(19) United States
(12) Patent Application Publication
(10) Pub. No.: US 2020/0020953 A1
(43) Pub. Date: Jan. 16, 2020

(54) ATMOSPHERIC PRESSURE PLASMA METHOD FOR PRODUCING PLASMA POLYMER COATINGS

(71) Applicants: Fraunhofer-Gesellschaft zur Foerderung der angewandten Forschung e.V., Muenchen (DE); Plasmatreat GmbH, Steinhagen (DE)

(72) Inventors: Christoph Regula, Bremen (DE); Joerg Ihde, Lilienthal (DE); Ralph Wilken, Rastede (DE); Jost Degenhardt, Bremen (DE); Alexander Knospe, Bad Muender (DE); Syed Salman Asad, Bielefeld (DE); Christian Buske, Bielefeld (DE)

(21) Appl. No.: 16/482,099

(22) PCT Filed: Jan. 31, 2018
(86) PCT No.: PCT/EP2018/052421

§ 371 Date: Sep. 26, 2019

(30) Foreign Application Priority Data
Jan. 31, 2017 (DE) 10 2017 201 559.4

(51) Int. Cl. H01M 4/66; B05D 1/00; H01G 11/26; H01G 11/86

(52) U.S. Cl. CPC H01M 4/667; B05D 1/62; H01G 11/86; H01M 4/661; H01G 11/26; H01M 4/668

(57) ABSTRACT

A method for depositing a plasma polymer layer in an atmospheric-pressure plasma on a metallic substrate, wherein the plasma is obtained by a discharge between two electrodes. At least one organic coating precursor compound is fed into the region of the relaxing plasma and is deposited on the metallic substrate as a plasma polymer layer. Nitrogen or a forming gas is used as a treatment gas and the at least one organic coating precursor compound is selected from various compounds. Also disclosed is an article, an electrode and a capacitor which utilize the method and include a metallic substrate having a surface and a plasma polymer layer on the surface. Also disclosed is a method for producing the electrode or for producing the capacitor, a battery cell or a lithium-ion accumulator which comprises the electrode.

### FIELD OF THE INVENTION

The present invention relates to adhesion promoting layers suitable in particular for electrodes in batteries and accumulators due to their good conductivity or their low transition resistance. According to a first aspect the invention relates to an atmospheric pressure plasma method for deposition of such layers on a metallic substrate. According to further aspects the invention relates to an article, an electrode, a capacitor, a method for producing the electrode, a method for producing the capacitor, a battery cell and a lithium-ion accumulator. The present invention is based on the surprising finding that the feeding of organic precursor compounds into the relaxing area of an atmospheric pressure plasma enables the deposition of a preferably organic plasma polymer layer, which is suitable as an adhesion promoting layer between a metallic electrode surface and an active material. It was proven that the layer has good adhesion features and low transition resistance between a metallic electrode surface and an active material.

### PRIOR ART

A coating of the metallic substrates, for example metal films, directly after their production is necessary for the production of electrodes for battery cells to protect the cleaned metal surface against oxidation and improve adherence of the active material of the battery cell. One important requirement of such a layer is good adhesion features. In order to reduce the transition resistance between the metal surface and the active material, which enables the construction of thicker active material layers amongst other things, good electric conductivity of the adhesion promoting layer is also required.

Thin metal films like those described in EP 2866285 Al are currently chemically degreased and pickled following production, and an antioxidatively acting chemical such as for example benzotriazole is applied. The films are then normally precision cleaned prior to processing and the active material is applied to the surface in the form of a dispersion, in particular by means of a slurry, and dried. This cleaning can be carried out as described in DE 19702124 A1 by means of corona discharge in a non-thermal plasma. DE 4228551 A1 describes a cleaning of surfaces in low pressure plasma. Cleaning occasionally takes place prior to plasma treatment by means of a solvent, for example through automated wiping. Micro-structuring can also take place prior to the slurry treatment. The aim of all treatments is the improvement of the connection of the active material with the metal surface of the electrode to reduce transition resistance and to extend the stability of the active material on the electrode by means of improved adherence strength.

According to numerous patent applications galvanic processes in an aqueous and non-aqueous phase for depositing adhesion promoting layers were used especially on metallic materials. EP 0 328 128 A1 can be cited as one example.

Methods for layer deposition based on plasma activated gaseous phase layer deposition at low pressure (for example from DE 197 48 240 A1) or at atmospheric pressure (for example WO 01/32949 A1) are known.

Plasma processes for the pre-treatment of material surfaces, with which good adhesive features of the material surfaces are to be produced without leading to a deposition of layers, are also known. We can for example refer to DE 43 25 377 C1, EP 0 761 415 A2 and DE 44 07 478 A1 by way of example.

P. Brinkmann et al., Plasma Processes and Polymers 2009, 6 p. 496-p. 502, describe the application of adhesion promoting layers to aluminium. Organo-silicon precursors such as HMDSO, tetraethyl orthosilicate (TEOS) and octamethyl cyclotetrasiloxane (OMCTS) are deposited here with, amongst others, a commercially available Open Air® plasma jet. In the plasma source used the plasma is generated through arc discharge. The plasma source used equals that described in WO 01/32949. The scientific publication offers no further details regarding the supply of precursors. An analysis of the deposited adhesion promoting layers by means of XPS resulted in an almost stoichiometric SiO₂ irrespective of the precursor compound used apart from a residual carbon content of 0.5-1 atom %.

As described in US 2009/0220794 A1 siliceous coatings can have surface functionalities that are very suitable for the connection of further materials. However, due to the low conductivity of silicates silicon-based adhesion promoting layers have only limited suitability for coating electrode surfaces.

DE 10 2006 003 940 A1 describes the pre-treatment of the surface of a component, in particular a car body component, with an atmospheric pressure plasma for activation, for example before a seal is glued on.

WO 2004/035857 A2 relates to a method for the application of a plasma polymer coating which can be used as an adhesive layer on a substrate. In WO 2004/035857 A2 the precursor material comprises double and triple bonds and the deposition on the substrate in the plasma condition is to be realised in such a way that at least part of the double and triple bonds is retained. Examples of precursor compounds mentioned are acetylene, cyclopentadiene and cyclooctadiene. In the embodiment example of WO 2004/035857 A2 acetylene is used as a precursor compound and a plasma nozzle according to DE 195 32 412 C2 is used. Deposition takes place on noryl. WO 2004/035857 A2 describes the good adhesion features of the plasma polymer layer of the noryl coated in this way, in particular the high adherence of the polymer EPDM to the coated noryl.

WO 2004/035857 A2 describes that the outlet temperature from such a plasma nozzle is generally higher than 1000 K. Feeding of the precursor compound is realised via the nozzle head in WO 2004/035857 A2 as described in WO 01/32949. As the light arc in the plasma nozzle reaches as far as the outlet opening of the nozzle in DE 195 32 412 C2 the feeding therefore takes place into the light arc.

### SUMMARY OF THE INVENTION

Against the background of the previously discussed prior art the invention is based on the problem of providing a layer that can be arranged as an adhesion promoting layer between a metallic electrode surface and an active material. This application places the following requirements on the layer:
adhesion of an active material with high adhesive strength directly on the layer
low transition resistance in a layer electrode comprising a metal substrate, the layer and an active material
a thermal expansion coefficient of the layer, which permanently enables good adhesion of the layer to the active material (cycle stability) when the volume of the active material changes during the discharge/charge cycle and prohibits ageing of the electrode in this way
preferably good ageing protection for the metal surface of the electrode, for example against atmospheric ageing

This problem is solved according to the invention by a method with the features of claim 1, an article with the features of claim 8, an article with the features of claim 9, an article with the features of claim 14, an electrode with the features of claim 15, a capacitor with the features of claim 19, a production method with the features of claim 20, a production method with the features of claim 23, a battery cell with the features of claim 24 and a lithium-ion accumulator with the features of claim 25. Preferred embodiments are the subject of the subclaims.

It has surprisingly been found that plasma polymer, in particular organic plasma polymer layers with good adhesion promoting features, can be produced by means of the method according to the invention, which lead to low transition resistance between the metallic substrate and the active material in a layer electrode.

According to the first aspect the present invention provides a method for depositing a plasma polymer layer in an atmospheric pressure plasma onto a metallic substrate. With this method a plasma is generated through a discharge between electrodes and at least one organic coating precursor compound is fed into the area of the relaxing plasma and deposited as a plasma polymer layer onto the metallic substrate, wherein nitrogen or forming gas, preferably nitrogen, is used as a process gas and the at least one organic coating precursor compound is selected from the group consisting of cyclic non-functionalised hydrocarbons and hydrocarbons with at least one functional group, selected from an alcohol group, carbonyl group, carboxyl group, amino group, multiple carbon-carbon bonds, multiple carbon-nitrogen bonds and multiple nitrogen-nitrogen bonds.

According to the first aspect the at least one organic coating precursor compound used in the method can also be a heterocyclic compound.

The method is based on the surprising finding that feeding specific organic precursor compounds into the relaxing area of an atmospheric pressure plasma under certain conditions leads to the deposition of a plasma polymer layer that enables good adhesion of active material on a metal surface and leads to low transition resistance in the electrode.

The second aspect of the invention relates to an article comprising a metallic substrate with a surface and a plasma polymer layer on the surface and is characterised in that the plasma polymer layer contains conjugated multiple bonds.

According to the third aspect the invention relates to an article comprising a metallic substrate with a surface and a preferably organic plasma polymer layer on the surface and is characterised in that the plasma polymer layer is deposited at atmospheric pressure.

The fourth aspect of the invention relates to an article comprising a metallic substrate with a surface and a plasma polymer layer deposited onto the surface, wherein the plasma polymer layer is obtainable with the method according to the first aspect of the invention.

According to the fifth aspect the invention provides an electrode comprising a metallic substrate with a surface, a plasma polymer layer on the surface of the metallic substrate, and a layer with an active material on the surface of the plasma polymer layer that faces away from the substrate.

According to the sixth aspect the invention relates to a capacitor comprising a metallic substrate with a surface, a plasma polymer layer on the surface of the metallic substrate and a layer with an active material on the surface of the plasma polymer layer that faces away from the substrate, wherein the plasma polymer layer is defined according to at least one of the aspects 2 to 4 of the invention.

According to the seventh aspect the invention relates to a method for producing an electrode according to the fifth aspect of the invention. The method comprises the following steps: cleaning a surface of a metallic substrate, depositing a plasma polymer layer onto the surface of the metallic substrate, and applying an active material onto the surface of the plasma polymer layer that faces away from the substrate, characterised in that the plasma polymer layer is deposited at atmospheric pressure.

According to the eighth aspect the invention is aimed at a method for producing a capacitor according to the sixth aspect of the invention. The method comprises the following steps: cleaning a surface of a metallic substrate, depositing a plasma polymer layer onto the surface of the metallic substrate, and applying an active material onto the surface of the plasma polymer layer that faces away from the substrate, characterised in that the plasma polymer layer is deposited at atmospheric pressure.

According to the ninth aspect the invention relates to a battery cell comprising an electrode according to the fifth aspect of the invention.

According to the tenth aspect the invention relates to a lithium-ion accumulator, comprising an electrode according to the fifth aspect of the invention.

### BRIEF DESCRIPTION OF DRAWINGS

FIG. 1 illustrates the deposition of a plasma polymer layer onto a substrate with the method according to the invention, wherein the organic coating precursor compound of this layer is fed into the afterglow area of an atmospheric pressure plasma jet.

FIG. 2 shows a schematic section view of a nozzle head with a grid structure, which can be used according to the invention.

FIG. 3 shows an infrared spectrum of a plasma polymer layer according to the invention.

FIG. 4 compares an infrared spectrum of a plasma polymer layer according to the invention with the infrared spectrum of the coating precursor compound.

FIG. 5 shows a schematic section view of a multi-part nozzle head which can be used according to the invention, with an internal structure for hindering an entry of the light arc or the discharge similar to a light arc into the feed area in the nozzle head.

### DETAILED DESCRIPTION OF THE INVENTION

Method for Depositing a Plasma Polymer Layer

The method according to the first aspect of the invention is defined in patent claim 1 and in the paragraph summary of the invention (1). Preferred embodiments are the subject of dependent patent claims 2-7 and 26 as well as features sets 2-15 and 45 to 53.

The method according to the first aspect of the invention is a method for depositing a plasma polymer layer in an atmospheric pressure plasma onto a metallic substrate.

Atmospheric Pressure Plasma

An “atmospheric pressure plasma”, also described as an AP plasma or normal pressure plasma, is understood as a plasma where pressure approximately equals atmospheric pressure. C. Tendero et al. provide an overview over atmospheric pressure plasmas in “Atmospheric pressure plasmas: A review”, Spectrochimica Acta Part B: Atomic Spectroscopy, 2006, p. 2-30.

The deposition of the plasma polymer layer under atmospheric pressure onto the surface of the metallic substrate enables a particularly simple and cost-effective realisation of the method according to the invention, as no low-pressure means, such as for example low-pressure chambers, vacuum pumps, vacuum valves and suchlike, are required and process management is simplified.

The features of plasma polymer layers strongly depend on the deposition conditions. A plasma polymer layer deposited at atmospheric pressure contains oxygen and nitrogen even when using oxygen- and nitrogen-free coating precursor compounds. Secondary reactions with ambient atmosphere have also been proven to introduce a small proportion of oxygen functionalities on the immediate surface of plasma polymer layers deposited at low pressure. The concentration of the oxygen functionalities is however lower than that of a plasma polymer layer deposited at atmospheric pressure. The capture of nitrogen in the plasma polymer layer at atmospheric pressure has also been observed. In a plasma polymer layer deposited at low pressure the capture of nitrogen happens only when using nitrogen as a process gas and to a typically lower degree compared to a plasma polymer layer deposited at atmospheric pressure. As oxygen and nitrogen containing functional groups contribute towards the reactivity and the adhesion promoting effect in the plasma polymer layer an atmospheric pressure plasma process is of advantage.

Electrodes in the method according to the first aspect of the invention are understood as elements for generating the atmospheric pressure plasma which serve as exit or end point of the discharge filaments at least some of the time. In the method according to the invention several electrodes made of the same or different materials can be used. The discharge is preferably an arc-like discharge. In principle we differentiate between the active and the relaxing area of the plasma in a plasma.

An active plasma area is generally understood as a plasma area located in the volume delimited by the electrodes, between which a voltage is applied, which generates the plasma. Free electrons and ions are found separately in the active plasma area.

The area of the relaxing plasma is located outside of the excitation zone, which is delimited by the electrodes. The relaxing area of the plasma is also described as “afterglow” area. No or only a few free electrons and ions are present in the area of the relaxing plasma, but excited atoms or molecules are present instead. The area of the relaxing plasma thus lies outside of the area of the discharge, which is preferably a light arc or a light arc-like discharge. A light arc-like discharge in the sense of the invention is for example a light arc that does not burn permanently, such as for example a pulsed light arc. To put it differently, the term “light arc” used here can also include a not permanently burning light arc, for example a pulsed light arc. In a plasma nozzle the relaxing area of the atmospheric pressure plasma is the area on the outflow side of the excitation zone (i.e. starting at the electrode closer to the outlet of the plasma nozzle).

In the method according to the first aspect of the present invention feeding the coating precursor compound takes place in the area of the relaxing plasma.

Process Gas

Nitrogen or forming gas is used as a process gas according to the invention for generating the most oxygen-free atmosphere possible in the plasma nozzle, so that a combustion and an overly strong fragmentation of the coating precursor compounds can be suppressed as much as possible. Gas mixtures of nitrogen or argon and hydrogen with a reducing effect are described as forming gas in the sense of the invention. Process gas is introduced into a device, in particular a plasma nozzle, via a line for generating the atmospheric pressure plasma. A jacket jet of inert gas is preferably additionally generated around the nozzle outlet of the plasma nozzle for reducing the oxygen concentration in the area of the relaxing plasma still further.

Plasma Nozzle

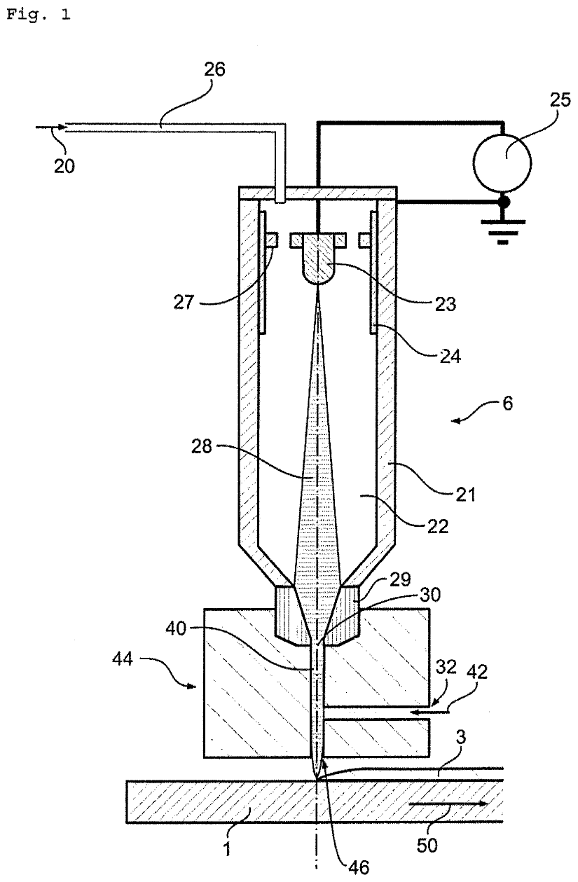

The plasma of the method according to the invention is preferably a plasma jet. A plasma jet can be generated through a plasma nozzle. The plasma under atmospheric pressure is preferably generated with an atmospheric pressure plasma nozzle with the method according to the invention. The basic construction of such a plasma nozzle is explained in more detail as follows with reference to FIG. 1. The plasma nozzle 6 has an electrically conductive housing 21, which is preferably designed as an elongated, in particular tubular shape. The housing forms nozzle channel 22 through which process gas flows. An electrode 23 is arranged in the nozzle channel, preferably coaxially. A pipe 24 made from a dielectric material, for example a ceramic pipe, is inserted in the nozzle channel 22. A voltage is applied between the electrode and the housing by means of the high-frequency generator 25. Process gas 20 is introduced to the nozzle channel through a line 26, namely preferably in such a way that it flows through the channel whilst swirling. This flow of the process gas can be realised with a swirling means 27. It can be a plate with holes.

When operating the atmospheric pressure plasma nozzle the plasma discharge 28, for example an arc-like discharge, runs from the tip of the central electrode 23 substantially in an axial direction of the nozzle channel 22 to the counter electrode 29, which is earthed like the housing 21. This causes a plasma jet 40 to exit directly below the nozzle outlet 30. As a result a plasma jet in the shape of a “flame” is generated below the nozzle opening when operating the plasma nozzle. In principle any plasma nozzle can be used with the method according to the invention. The PlasmaPlus® System of company Plasmatreat (Steinhagen, Germany) is preferably used.

The relaxing area of the atmospheric pressure plasma, which can also be described as the afterglow area, lies outside of the excitation zone delimited by the electrodes. Consequently the relaxing area of the plasma jet 40 is located between the nozzle outlet 30 and the substrate 1 in FIG. 1.

In a particularly preferred embodiment a plasma nozzle comprising the following elements is used: a housing which forms a nozzle channel through which process gas flows, an electrode arranged in the nozzle channel, a counter electrode, and a high-frequency generator for applying a voltage between the electrode and the counter electrode for forming a plasma jet that exits from an outlet of the housing, a coating nozzle head with an internal grid structure arranged in a nozzle channel between the electrode and the outlet, and a means for feeding the evaporated, at least one organic coating precursor compound into the plasma jet in the relaxing area of the plasma in the nozzle head.

In a further preferred embodiment the housing itself constitutes the counter electrode of the electrode arranged in the nozzle channel.

High frequency is understood in the sense of the invention as frequencies within a range of 100 Hz to 1 MHz, preferably 1 to 100 kHz, more preferably 10 to 40 kHz. The high-frequency generator which can be used according to the invention is therefore operated within this frequency range.

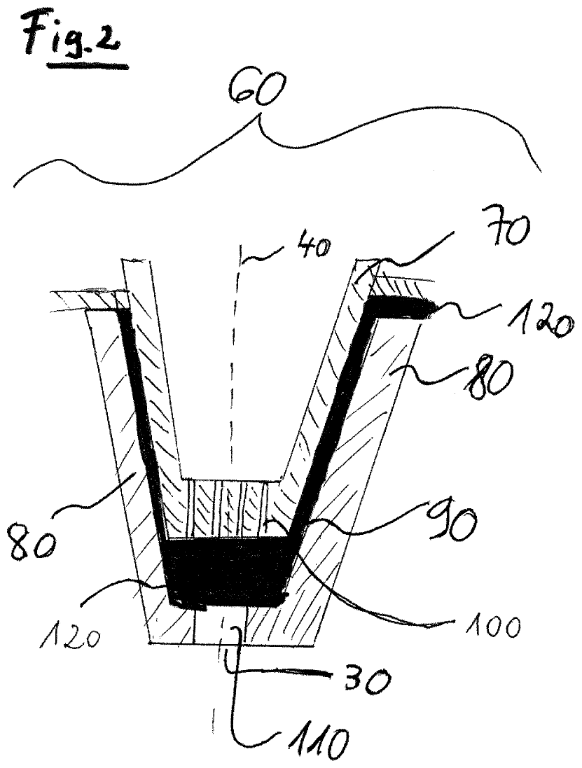

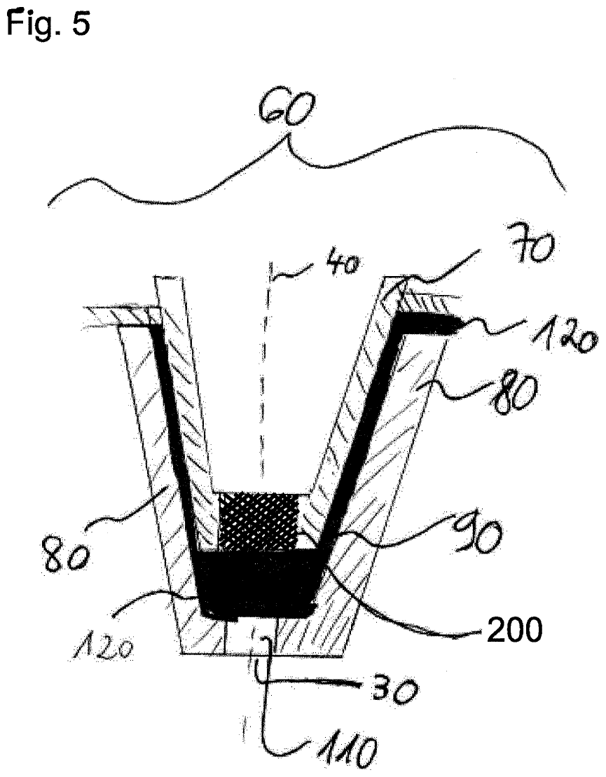

In a further preferred embodiment a multi-part coating nozzle head is used, which comprises a means for hindering the entry of the light arc or the light arc-like discharge into the lower part of the coating nozzle head. A multi-part coating nozzle head which can be used according to the invention, which comprises such a means, is for example shown in FIGS. 2 and 5 and will be described hereafter.

A means for hindering the entry of the light arc or the light arc-like discharge is understood as a means that shields the light arc or the light arc-like discharge. The means for hindering the entry of the light arc or the light arc-like discharge could mostly retain potential-carrying components of the plasma, especially the excitation arc (active excitation zone of the plasma). The means for hindering the entry of the light arc or the light arc-like discharge preferably forms a shield element with an internal part of a multi-part coating nozzle head, and more preferably a Faraday cage. A shield element in the sense of the invention is understood as a means with noise reduction of at least 50 dB, preferably at least 70 dB and more preferably at least 110 dB. Standard IEEE-STD 299.1-2013 for example constitutes a common noise reduction measuring method.

The coating nozzle head with an internal grid structure is described in the final report of the BMBF project “Basic investigation into the suitability of plasma jet coatings for improving the reliability of circuit boards and OLEDs” on page 25. Thanks to the internal grid structure the coating nozzle head can mostly retain potential-carrying components of the plasma, especially the excitation arc (active excitation zone of the plasma). Contrary to the usual plasma nozzles this coating nozzle head enables the feeding of thermally sensitive organic coating precursor compounds directly at or into the plasma nozzle head in a mostly potential-free relaxing plasma. An efficient, mostly non-destructive excitation of the organic coating precursor compound can thus be realised in the plasma jet using the coating nozzle head with an internal grid structure.

One embodiment of the nozzle head with an internal grid structure, which can be used to advantage according to the invention, is schematically illustrated in FIG. 2. This shows that the nozzle head 60 consists of an internal part 70 and an external part 80. The internal part 70 is equipped with an internal grid structure 100 at the outlet. The internal grid structure 100 has openings or holes. The internal part 70 retains the light arc. The light arc is preferably held inside the area of the active excitation, namely the active plasma area, in this way. The external part 80 forms a circumferential gap 90 together with the internal part 70, into which the evaporated, for example gaseous coating precursor compound 120 is fed and then arrives in the relaxing area of the plasma 110 directly under the grid structure 100. Directly after this the gas containing the excited coating precursor compound leaves the nozzle head 60 at the nozzle outlet 30. The vertical plasma jet 40 exits directly below the nozzle outlet 30.

In a further aspect of the present invention a multi-part coating nozzle head consisting of an internal part and an external part is used. An embodiment of the multi-part coating nozzle head 60 is schematically illustrated in FIG. 5. The internal part 70 has an exit at its lower end. The exit is equipped with an internal structure 200 that retains the light arc or the light arc-like discharge. The light arc or the light arc-like discharge is thus preferably held inside the area of the active excitation, i.e. the active plasma area above the internal part 70. The external part 80 forms a circumferential gap 90 together with the internal part 70, into which the evaporated, for example gaseous coating precursor compound 120 is fed and then arrives in the relaxing area of the plasma 110 directly below (downstream of) the internal part. Immediately after this the gas containing the excited coating precursor compound leaves the nozzle head 60 at the nozzle outlet 30. The vertical plasma jet 40 exits directly below the nozzle outlet 30. The space 90 in the nozzle head that is formed by the internal part 70 and the external part 80 of the nozzle head is also described as the feed area. The exit at the lower end of the internal part 70 thus constitutes the transition to the feed area 90.

The internal structure 200 at the lower end (exit) of the internal part 70 of the nozzle head 60 constitutes a means for hindering the entry of the light arc or the light arc-like discharge into the feed area 90. This means can mostly retain the potential-carrying or averaged potential-carrying components of the plasma or the plasma excitation, so that a mostly potential-free relaxing plasma is present in the feed area 90 inside the nozzle head 60. This enables a mostly non-destructive, efficient excitation of the organic coating precursor compound in the plasma jet 40 in the nozzle head 60.

In a preferred embodiment the internal part 70 of the nozzle head forms a shield element, more preferably a Faraday cage, together with the internal structure 200 at the exit of the internal part 70 that retains the light arc or the light arc-like discharge. A shield element in the sense of the invention is understood as a means that has noise reduction of at least 50 dB, preferably at least 70 dB, and more preferably of at least 110 dB. Standard IEEE-STD 299.1-2013 for example constitutes a common measuring method for determining the noise reduction.

The internal structure 200 at the exit of the internal part 70 of the nozzle head 60, which acts as a means for hindering entry of the light arc or the light arc-like discharge into the feed area 90, can be the internal grid structure already described above, a hole structure, namely a structure equipped with openings or holes, a narrowing of the exit of the internal part 70, preferably by means of an edge, or an isolator. If the structure that retains the light arc or the light arc-like discharge is an isolator, for example aluminium oxide, the discharge takes place in the area of the nozzle head above the insulation. The isolator comprises at least one bore, through which the plasma jet can exit into the feed area. The isolator can also be a gas. The downward extension of the nozzle head can thus effect an increased distance of the location where the coating precursor compound is fed in from the discharge area, so that the light arc or the light arc-like discharge no longer reaches the feed-in location. This can also be realised in that a tube is attached to the lower part of the nozzle head and feeding takes place at the end of the tube. In this case a larger gas volume exists between the internal part 70 and the external part of the tube, which can act in an insulating way.

Deposition of a Plasma Polymer Layer

The following reaction steps can lead to the deposition of a plasma polymer layer:

In a first step the molecules of the organic coating precursor compound fed into the relaxing area of the plasma are excited by the plasma. Feeding the organic coating precursor compound into the relaxing area of the plasma in a nitrogen atmosphere leads to an excitation of the coating precursor compound without an excessively strong fragmentation of the molecules here. Feeding into the relaxing area of the plasma can also reduce the undesired oxidation of the fragmented molecules into carbon monoxide or carbon dioxide. The local nitrogen atmosphere in the relaxing area of the plasma also reduces oxidation. The excited molecules of the organic coating precursor compound can react with further particles in the gaseous phase. Following transport to the substrate surface the adsorption takes place on the substrate surface. The excited molecule can react further with neighbouring particles on the substrate surface, so that a plasma polymer layer is created. The collision of particles in the gaseous phase or of a particle with the substrate surface can result in additional excitation.

It has been found to be of particular advantage as part of the present invention to use a pulsed discharge with a primary power input between 50 and 4000 W, preferably between 100 and 2000 W, and particularly preferably between 150 and 1500 W for obtaining the desired plasma polymer layers.

Metallic Substrate

The metallic substrate in the sense of the invention is in particular a solid body comprising mostly metal (i.e. >50 wt %), preferably a solid body comprising at least 90 wt %, more preferably at least 95 wt %, most preferably at least 99 wt % metal. The metal/metals can also exist in the form of metal alloys. The metallic substrate is preferably a metal film. Metallic substrates, in particular metal films, made of copper, silver, iron, nickel, cobalt and aluminium are particularly preferred. The most preferred metallic substrates are aluminium and copper films. The metal films used, in particular the aluminium and copper films, are preferably produced through rolling or electrolytically. The surface of the metallic substrate can be cleaned by means of a plasma or chemically cleaned prior to depositing the plasma polymer layer. Contamination, for example oxides, can be removed from the surface of the metallic substrate with the aid of a solvent, for example isopropanol, in this way. In addition, the surface of the metallic substrate can be transferred into a more reactive condition, for example by means of chemical pre-treatment (for example pickling) or pre-treatment in a plasma, for an improved binding of the plasma polymer layer to be deposited onto the same.

Organic Coating Precursor Compound

As a mostly non-destructive feeding of the organic coating precursor compounds is possible with the method according to the invention as described above, the features of the plasma polymer layer will depend on the selection of the organic coating precursor compound(s), amongst other things.

It has surprisingly been observed that the functional groups included in a plasma polymer layer deposited according to the method according to the invention are maintained in the organic coating precursor compound to a certain degree (see example). This leads to a residual chemical activity or a latent reactivity of the plasma polymer layer deposited according to the method according to the invention. It is suspected that the residual activity of these functional groups contributes towards the good adhesion properties of the plasma polymer layer.

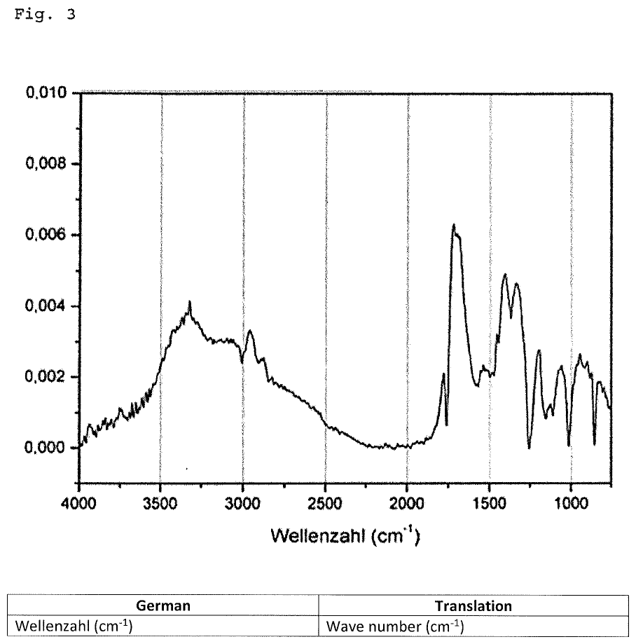

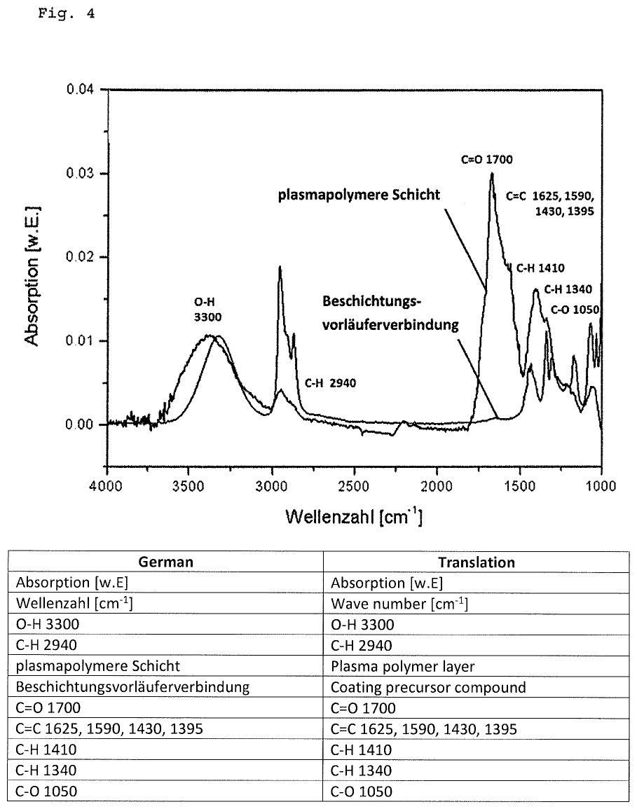

It has surprisingly been observed that double bonds, in particular conjugated double bonds, are present in a plasma polymer layer deposited according to the method according to the invention, as has been proven with the aid of infrared spectroscopy (see FIGS. 3 and 4). C═C double bonds can be allocated to bands with wave numbers within a range of 1640 to 1680 cm⁻¹. The IR bands of C═C double bonds without conjugation are typically less pronounced. The bands of conjugated double bonds are also often offset in the direction of lower wave numbers (cm⁻¹). Bands within a range of 3300, 1700 and 1050 cm⁻¹ show the presence of oxygen functionalities in the plasma polymer layer. The clearly pronounced C—H vibrations at 2940, 1410 and 1340 cm⁻¹ show that an organic plasma polymer layer has been deposited and are an indication for the weak fragmentation of the coating precursor compound in the relaxing plasma, as the same vibrations of the precursor compound are maintained, although weaker.

Measuring the infrared spectra can be realised with the aid of infrared reflection absorption spectroscopy sampling technology, which is abbreviated to IRRAS hereafter. IRRAS is an infrared spectroscopy sampling technology for the non-destructive examination of thin layers and constitutes a mixed form of transmission and reflection infrared spectroscopy.

The infrared spectra of the plasma polymer layer were measured with an IR spectrometer of the type “Equinox 55” from company Bruker. The IRRAS measuring method was here applied in reflection with an angle of 32°, a wave number of 700-4000 cm⁻¹ with 32 scans on a copper-diffused wafer with 600 nm PVD copper. PVD copper in the sense of the invention describes copper deposited through physical gas deposition (Physical Vapour Deposition, PVD).

Infrared spectra of the organic coating precursor compounds can be measured by means of ATR spectroscopy in a liquid phase. ATR (Attenuated Total Reflection) spectroscopy is a measuring method of infrared spectroscopy that is suitable for liquid samples.

It is suspected that the surprisingly high durability of the adhesion of the active material to the plasma polymer layer on the surface of a metallic substrate is due to the suitable thermal expansion coefficient of the plasma polymer layer.

Conjugated double bonds are systems with alternating double and single bonds. Systems with just one double bond or with several double bonds in which more than one or no single bond lies between the double bonds are described as non-conjugated or isolated.

It is suspected that these double bonds lead to improved electric conductivity of the layer, and therefore to a lower transition resistance of the adhesion promoting layer in an electrode. It is further assumed that the double bonds contribute towards the good adhesion properties of the plasma polymer layer according to the invention thanks to their high chemical reactivity.

According to the surprising finding that the functional groups of the organic coating precursor compounds are maintained to a certain part in a plasma polymer layer deposited according to the method according to the invention, coating precursor compounds containing double bonds and conjugated it electron systems are therefore also used.

The organic coating precursor compound(s) is/are selected from the group consisting of cyclic non-functionalised hydrocarbons and hydrocarbons with at least one functional group. The at least one functional group is one of the following groups: an alcohol group, carbonyl group, carboxyl group, amino group, multiple carbon-carbon bonds, multiple carbon-nitrogen bonds and multiple nitrogen-nitrogen bonds.

According to one aspect of the invention the hydrocarbon with at least one functional group is a non-cyclic hydrocarbon with at least one functional group selected from a C—C double bond, C—C triple bond and a carbonyl group, or a cyclic hydrocarbon with at least one functional group selected from a C—C double bond, a C—C triple bond, a carbonyl group, an alcohol group and an amino group.

The cyclic hydrocarbon with at least one functional group selected from a C—C double bond, C—C triple bond, a carbonyl group, an alcohol group and an amino group can be an aromatic or non-aromatic compound and is preferably a non-aromatic compound, and more preferably a non-aromatic compound with at least two C—C double bonds and/or a cyclic ketone. The cyclic non-aromatic compound can for example be cyclooctadiene, phellandrene, limonene, a terpinene or a quinone.

The non-cyclic hydrocarbon is preferably a hydrocarbon with at least one C—C triple bond and/or at least two C—C double bonds, and more preferably acetylene or squalene.

According to a further aspect of the invention the organic coating precursor compound is a heterocyclic compound. The heterocyclic compound is preferably a substituted or non-substituted 5-ring or 6-ring with a heteroatom selected from the group of oxygen, nitrogen and sulphur, and is more preferably a non-aromatic compound. Most particularly preferred are tetrahydrofuran, tetrahydrothiophene, piperidine, pyrrolidine, 2,3-dihydrofuran, 2,5-dihydrofuran, 2,3-dihydrothiophene, 2,5-dihydrothiophene, 1-pyrroline, 2-pyrroline and 3-pyrroline.

In one preferred embodiment the at least one organic coating precursor compound is evaporated and fed into the area of the relaxing plasma in an evaporated form.

In one preferred embodiment the at least one organic coating precursor compound is evaporated and fed into the area of the relaxing plasma as a gas mixture together with an inert gas, preferably nitrogen.

If more than one organic coating precursor compound is used, these can be fed into the relaxing plasma together as a mixture in a preferred embodiment.

If more than one organic coating precursor compound is used the various organic coating precursor compounds can be fed into the relaxing plasma separately at different points according to a further preferred embodiment. The organic coating precursor compounds are fed into the relaxing plasma further downstream as sensitivity increases (tendency to fragment) here in order to achieve a mostly non-destructive efficient excitation of the respective organic coating precursor compounds in the plasma jet. This means that less sensitive coating precursor compounds are preferably fed into the relaxing plasma further up (further upstream), whilst more sensitive coating precursor compounds are preferably fed in further down (further downstream).

The organic coating precursor compound is preferably a cycloalkane, a terpene or a cyclic hydrocarbon containing at least one amine and/or alcohol group. The coating precursor compound is more preferably limonene, cyclopentanol, cyclooctane or 1,5-cyclooctadiene.

The organic coating precursor compound can include an aromatic or a conjugated 71 electron system.

As the deposition of a siliceous coating precursor compound under atmospheric pressure plasma conditions leads to the forming of electrically insulating plasma polymer layers the at least one organic coating precursor compound preferably contains less than 10% silicon with regard to its total atomic number, and more preferably less than 5% silicon. In a particularly preferred embodiment the organic coating precursor compound is silicon-free.

Plasma Polymer Layer

The plasma polymer layer deposited onto the metallic substrate preferably has conjugated multiple bonds, which lead to high electrical conductivity of the plasma polymer layer and therefore to low transition resistance. The conjugated multiple bonds of the plasma polymer layer are preferably carbon-carbon, carbon-nitrogen or nitrogen-nitrogen double or triple bonds.

The coating according to the first aspect of the invention can also be realised during several coating cycles.

Corrosion inhibitors can be added to the layer with spray processes between individual coating cycles to improve its ageing protection. Corrosion inhibitors are added to prevent the development of rust on metal surfaces. Suitable corrosion inhibitors are for example benzotriazole, tolyltriazole, benzimidazole, borax, sodium benzoate, molybdenum, nitrate, nitrite, silicate, phosphorous and organic phosphorous compounds and solutions and mixtures of the said compounds.

The deposition of the plasma polymer layer can also take place in combination with the deposition of metal particles according to DE102009048397A1.

Article Comprising a Metallic Substrate and a Plasma Polymer Layer

The article according to the second aspect of the invention comprises a metallic substrate with a surface and a plasma polymer layer on the surface and is characterised in that the plasma polymer layer contains conjugated multiple bonds, in particular double and triple bonds, most particularly double bonds. Preferred embodiments are the subject of dependent patent claims 10-13 as well as of feature sets 18-25 and 54.

A plasma polymer layer in the sense of the invention is a polymer layer deposited in a plasma or with the aid of a plasma, which in particular has strong cross-linking through covalent bonds. The plasma polymer layer in the article according to the second aspect of the invention preferably contains carbon-carbon, carbon-nitrogen or nitrogen-nitrogen double or triple bonds, in particular double bonds.

The article according to the third aspect of the invention comprises a metallic substrate with a surface and a preferably organic plasma polymer layer on the surface and is characterised in that the plasma polymer layer is deposited at atmospheric pressure. Preferred embodiments are the subject of dependent patent claims 10-13 as well as of feature sets 18 and 20-25 and 54.

Preferred embodiments, which relate to the article according to the second as well as to the article according to the third aspect of the present invention, are described hereafter.

The plasma polymer layer is preferably organic. Organic compounds are understood as is customary in the sense of the present invention. This means they are carbonic compounds, in particular carbonic compounds with at least one carbon-hydrogen bond. In order to achieve a better conductivity of the plasma polymer layer the plasma polymer layer preferably contains less than 10% silicon and more preferably less than 5% silicon in the article according to the second and third aspect of the present invention with regard to its total atomic number. In a particularly preferred embodiment the plasma polymer layer is silicon-free.

The plasma polymer layer preferably comprises functional groups on the surface facing away from the substrate. In one preferred embodiment at least 10% of the surface atoms in the surface of the plasma polymer layer facing away from the substrate have an oxygenic functional group. The analysis of the deposited adhesion promoting layers can be realised by means of X-ray Photoelectron Spectroscopy (XPS). The recorded XPS signals of the functional groups can be analysed, and quantified in this way, with a fit function.

On the one hand a high carbon content is of advantage, as multiple carbon-carbon bonds can form conjugated double bond systems, contrary to oxygen, which probably contribute towards a high conductivity of the plasma polymer layer. On the other hand a certain content of oxygen and nitrogen is of advantage because these atoms can contribute towards the adhesive strength of the plasma polymer layer due to their high electronegativity and the formation of reactive functional groups.

The molar ratio of carbon to oxygen in the plasma polymer layer is therefore preferably greater than 2. The composition of the plasma polymer layer preferably contains minimally 50 and maximally 90 atomic percent carbon, minimally 0 and maximally 30 atomic percent oxygen, and minimally 0 and maximally 20 atomic percent nitrogen with regard to its total atomic number excluding hydrogen.

The thickness of the plasma polymer layer is preferably less than 1 μm, more preferably less than 100 nm, and most preferably less than 20 nm.

The plasma polymer layer preferably has a layer resistance within a range of 2 to 50,000 Ohm, more preferably a layer resistance of less than 35,000 Ohm, and most preferably a layer resistance of less than 20,000 Ohm at a layer thickness within a range of 10 to 100 nm. The layer resistance in the sense of the invention equals the impedance. The impedance is also described as alternating current resistance. In the present invention the impedance was determined by means of electrochemical impedance spectroscopy at 0.01 Hz. Electrochemical impedance spectroscopy determines the impedance of electrochemical systems as a function of the frequency of an alternating voltage or alternating current. The method of electrochemical impedance spectroscopy is known to the person skilled in the art and is for example described in the online encyclopaedia Rompp Online (https://roempp.thieme.de/roempp4.0/do/data/RD-09-00371).

The plasma polymer layer preferably has a dielectric constant within a range of 50 to 20,000, more preferably within a range of 100 to 10,000, and most preferably within a range of 150 to 5,000 at a layer thickness within a range of 10 to 100 nm. In the present invention the dielectric constant was determined by means of electrochemical impedance spectroscopy within a frequency range of 1 Hz to 10 kHz.

The articles according to the second and third aspect of the invention are preferably obtainable with the method according to the first aspect of the invention.

Electrode and Capacitor

According to the fifth aspect the invention provides an electrode with a metallic substrate with a surface, a plasma polymer layer on the surface of the metallic substrate, and a layer comprising an active material on the surface of the plasma polymer layer facing away from the substrate. Preferred embodiments are the subject of dependent claims 16-18 as well as the features sets 28-30.

According to the sixth aspect the invention relates to a capacitor comprising a metallic substrate with a surface, a plasma polymer layer on the surface of the metallic substrate, and a layer comprising an active material on the surface of the plasma polymer layer facing away from the substrate, wherein the plasma polymer layer is defined according to at least one of the aspects 2 to 4 of the present invention. Preferred embodiments are the subject of features sets 32-34.

Features and preferred embodiments relating to the electrode according to the fifth as well as the capacitor according to the sixth aspect of the present invention are described hereafter.

Metallic Substrate

Those substrates already described previously can be used as metallic substrates of the electrode or the capacitor. The metallic substrate is preferably a metal film. Metal films made of copper, silver, iron, nickel, cobalt and aluminium are particularly preferred. The metallic substrates preferred most of all are aluminium and copper films. The aluminium and copper films used are preferably produced through rolling or electrolytically.

Plasma Polymer Layer

The plasma polymer layer is preferably produced according to the method according to the first aspect of the present invention. The plasma polymer layer is preferably a plasma polymer layer as defined in the second and third aspect of the invention.

Active Material

Materials, namely electrode active materials, that store or release ions during their oxidation or reduction are described as an active material in the sense of the invention. Preferred active materials are lithium transition metal oxide compounds such as for example lithium iron phosphate (LiFePO₄), lithium cobalt oxide (LiCoO₂), lithium manganese oxide spinel (LiMn₂O₄) or lithium nickel cobalt manganese oxide (Li (NiₓCo_{y}Mn_{z}) O₂). Lithium transition metal oxide compounds can reversibly store lithium ions in a reversible redox cycle during their reduction and release these again during the following oxidation. The lithium transition metal oxide compounds can also be doped with other chemical elements, in particular with further transition materials. The active material is more preferably lithium nickel cobalt manganese oxide (Li(NiₓCo_{y}Mn_{z})O₂). Lithium nickel cobalt manganese oxide is also abbreviated to NCM in the present invention. NCM is used to advantage as an active material of the cathode of a battery cell or a lithium ion accumulator. Compared to lithium cobalt oxide doping with manganese achieves higher thermal stability and an improved electromagnetic behaviour during the discharge/charge cycle.

Method for Producing an Electrode and Method for Producing a Capacitor

According to the seventh aspect the invention relates to a method for producing an electrode according to the fifth aspect of the invention. The method comprises the following steps: cleaning a surface of a metallic substrate, depositing a plasma polymer layer onto the surface of the metallic substrate, and applying an active material to the surface of the plasma polymer layer facing away from the substrate, characterised in that the plasma polymer layer is deposited at atmospheric pressure. Preferred embodiments are the subject of dependent patent claims 21 and 22 as well as of features sets 36-38.

According to the eighth aspect the invention is aimed at a method for producing a capacitor according to the sixth aspect of the invention. The method comprises the following steps: cleaning a surface of a metallic substrate, depositing a plasma polymer layer onto the surface of the metallic substrate, and applying an active material to the surface of the plasma polymer layer facing away from the substrate, characterised in that the plasma polymer layer is deposited at atmospheric pressure. Preferred embodiments are the subject of features sets 40-42.

Features and preferred embodiments relating to the method according to the seventh as well as to the method of the eighth aspect of the present invention are described hereafter.

Dispersion

The active material is preferably applied in the form of a dispersion, in particular a slurry, to the surface of the side of the plasma polymer layer facing away from the substrate. Additives, solvents and binding agents can be included in the dispersion in addition to the active materials. The selection of the mixing and dispersion sequence must be adjusted to the electrode design to be produced. Dry solid components can be pre-mixed prior to adding the solvent and the binding agent. The dry mixture obtained in this way can be dispersed after adding the solvent. In a further embodiment of the present invention solid and liquid components can also be dispersed without prior pre-mixing of the dry components during one step. The dispersion can be applied with an application tool, for example a slotted nozzle, a scraper, an anilox roll etc.

Active Material

Preferred active materials are lithium transition metal oxide compounds such as for example lithium iron phosphate (LiFePO₄), lithium cobalt oxide (LiCoO₂), lithium manganese oxide spinel (LiMn₂O₄) or lithium nickel cobalt manganese oxide (Li(NiₓCo_{y}Mn_{z}) Cg). The active material is more preferably lithium nickel cobalt manganese oxide (Li (NiₓCo_{y}Mn_{z}) O₂). The active material is preferably used in powder form for improving the dispersion.

Calendaring and Drying

In one preferred embodiment of the method the active material is treated further after applying through calendaring and drying.

After coating the coated substrate can be dried. Drying can for example take place in air (in particular in dried air) or preferably in an inert gas atmosphere. In general the gas mixture can be selected as suitable for drying. Drying can take place at normal pressure or also at low pressure under a static or a dynamic vacuum. The solvent is removed from the substrate by supplying heat during drying and can be reclaimed or supplied to thermal disposal. Drying preferably takes place in a dryer envisaged for this. The dryer can be divided into different temperature zones for realising an individual temperature profile. After the drying run cooling of the films to room temperature can take place. During calendaring the coated substrate is for example compressed with one or more rotating roll pairs (roll calendaring). Compression can be carried out with an upper and a lower roll. The roll pair generates a line pressure to be defined precisely, with which the porosity of the coated substrate can be set. A constant line pressure is crucial for a defined surface structure with a defined porosity, which is in turn dependent on the surface consistency and concentricity accuracy of the rolls.

Further drying can be carried out after calendaring and preferably takes place in a vacuum.

Battery Cell and Lithium Ion Accumulator

According to the ninth aspect the invention relates to a battery cell comprising an electrode according to the fifth aspect of the invention.

The last aspect of the invention relates to a lithium ion accumulator comprising an electrode according to the fifth aspect of the invention.

The battery and the lithium ion accumulator preferably comprise at least one cathode, at least one anode and at least one electrolyte. The electrode according to the fifth aspect, which is included in the battery and the lithium ion accumulator, is preferably the cathode.

An embodiment for producing the battery cell and the lithium ion accumulator according to the last two aspects of the invention is described hereafter. The electrode, according to the fifth aspect as a cathode, is stacked or wound with an interim layer and an anode to form a cell. During the stacking process the electrode films are stacked by means of a repeated cycle of anode, separator, cathode. During winding a roll of overlaying bands is generated from a separator band, an anode band, a separator band and a cathode band. The material produced in this way is then inserted into a packet and filled with an electrolyte.

Graphite and related carbons, nanocrystalline, amorphous silicon, lithium titanates or zinc oxides are preferably used as anode material. Graphite and related carbons, where an intercalation of lithium takes place, are particularly preferred anode materials.

Dissolved lithium salts such as lithium hexafluorophosphate, lithium tetrafluoroborate or lithium bis(oxalato)borate are preferably used as an electrolyte. The solution is realised in water-free aprotic solvents such as ethylene carbonate, propylene carbonate, dimethyl carbonate, diethyl carbonate or 1,2-dimethoxyethane. Polymers of polyvinylidene fluoride or polyvinylidene fluoride hexafluoropropene or lithium phosphate nitride can also be used as an electrolyte.

The separator in the sense of the present invention is a material that spatially and electrically separates cathode and anode, i.e. the negative and positive electrode, in battery cells and accumulator cells. Microporous membranes, for example polymer films made of one or more layers, are preferably used as separators.

Features Sets

Embodiments of the various aspects of the invention are summarised into features sets hereafter.

(1) Method for depositing a plasma polymer layer in an atmospheric pressure plasma onto a metallic substrate, the plasma being generated by means of a discharge between electrodes,
characterised in that at least one organic coating precursor compound is fed into the area of the relaxing plasma and deposited onto the metallic substrate as a plasma polymer layer,
nitrogen or forming gas being used as a process gas and the at least one organic coating precursor compound being selected from the group consisting of heterocyclic compounds, cyclic non-functionalised hydrocarbons and hydrocarbons with at least one functional group, selected from an alcohol group, a carbonyl group, a carboxyl group, an amino group, a multiple carbon-carbon bond, a multiple carbon-nitrogen bond and a multiple nitrogen-nitrogen bond.

(2) Method according to features set (1), where the at least one organic coating precursor compound is fed into the area of the relaxing plasma as a gas mixture together with an inert gas, preferably nitrogen.

(3) Method according to features set (1) or (2), where the at least one organic coating precursor compound is evaporated and fed into the area of the relaxing plasma in an evaporated form.

(4) Method according to at least one of the preceding features sets, where the area of the relaxing plasma lies outside the discharge, which in particular is a light arc or a light arc-like discharge.

(5) Method according to at least one of the preceding features sets, where the discharge is a light arc-like discharge.

(6) Method according to at least one of the preceding features sets, where the plasma is a plasma jet.

(7) Method according to features set 6, wherein the plasma jet is generated by a plasma nozzle.

(8) Method according to features set (7), where a jacket jet of inert gas is generated around the nozzle outlet of the plasma nozzle.

(9) Method according to at least one of the preceding features sets, where the at least one organic coating precursor compound contains less than 10% silicon, and preferably less than 5% silicon, and is more preferably silicon-free with regard to its total atomic number.

(10) Method according to at least one of the preceding features sets, where the at least one organic coating precursor compound is a cycloalkane, a terpene or a cyclic hydrocarbon, which has at least one amine and/or alcohol group.

(11) Method according to features set (10), where the organic coating precursor compound is limonene, cyclopentanol, cyclooctane or 1,5-cyclooctadiene.

(12) Method according to at least one of the preceding features sets, where the organic coating precursor compound contains an aromatic or conjugated 71 electron system.

(13) Method according to at least one of the preceding claims, where the plasma polymer layer has conjugated multiple bonds.

(14) Method according to features set (13), where the conjugated multiple bonds are C—C, C—N, or N—N double or triple bonds.

(15) Method according to at least one of the features sets (1) to (14), where a plasma nozzle is used, which comprises the following elements:
a housing, which forms a nozzle channel through which a process gas flows,
an electrode arranged in a nozzle channel,
a counter electrode, and
a high-frequency generator for applying a voltage between the electrode and the counter electrode for forming a plasma jet, which exits from an outlet of the housing,
a coating nozzle head with an internal grid structure arranged in the nozzle channel between the electrode and the outlet, and
a means for feeding the evaporated, at least one organic coating precursor compound into the plasma jet in the relaxing area of the plasma in the nozzle head.

(16) Article comprising a metallic substrate with a surface and a plasma polymer layer on the surface, characterised in that the plasma polymer layer contains conjugated multiple bonds.

(17) Article comprising a metallic substrate with a surface and a plasma polymer layer on the surface, characterised in that the plasma polymer layer is deposited at atmospheric pressure.

(18) Article according to features set (16) or (17), in which the plasma polymer layer is an organic layer.

(19) Article according to features set (16) or (18), in which the conjugated multiple bonds are C—C, C—N or, N—N double or triple bonds.

(20) Article according to at least one of the features sets (16) to (19), in which the plasma polymer layer contains less than 10% silicon, preferably less than 5% silicon with regard to its total atomic number.

(21) Article according to features set (20), in which the plasma polymer layer is silicon-free.

(22) Article according to at least one of the features sets (16) to (21), in which at least 10% of the surface atoms have an oxygenic functional group on the surface of the plasma polymer layer facing away from the substrate.

(23) Article according to at least one of the features sets (16) to (22), in which the molar ratio C:O in the plasma polymer layer is greater than 2.

(24) Article according to at least one of the features sets (16) to (23), in which the composition of the plasma polymer layer with regard to its total atomic number without hydrogen

contains minimally 50 and maximally 90 atomic percent C,

minimally 0 and maximally 30 atomic percent 0, and

minimally 0 and maximally 20 atomic percent N.

(25) Article according to at least one of the features sets (16) to (24), wherein the plasma polymer layer is obtainable with the method according to claims 1 to 16.

(26) Article comprising a metallic substrate with a surface and a plasma polymer layer deposited on the surface, wherein the plasma polymer layer is obtainable with the method according to features sets (1) to (15).

(27) Electrode, which
has a metallic substrate with a surface,
comprises a plasma polymer layer on the surface of the metallic substrate, and
a layer comprising an active material on the surface of the plasma polymer layer facing away from the substrate.

(28) Electrode according to features set 27, in which the active material is lithium iron phosphate (LiFePO₄), lithium cobalt oxide (LiCoO₂), lithium manganese oxide spinel (LiMn₂O₄) or lithium nickel cobalt manganese oxide (Li (NiₓCo_{y}Mn_{z}) O₂).

(29) Electrode according to features set (27) or (28), wherein the plasma polymer layer is obtainable according to the method according to claims 1 to 16.

(30) Electrode according to features set (27) or (28), wherein the plasma polymer layer is defined as in at least one of the claims 17 to 25.

(31) Capacitor, which
comprises a metallic substrate with a surface,
a plasma polymer layer on the surface of the metallic substrate, and
a layer comprising an active material on the surface of the plasma polymer layer facing away from the substrate.

(32) Capacitor according to features set (31), in which the active material is lithium iron phosphate (LiFePO₄), lithium cobalt oxide (LiCoO₂), lithium manganese oxide spinel (LiMn₂O₄) or lithium nickel cobalt manganese oxide (Li (NiₓCo_{y}Mn_{z})O₂).

(33) Capacitor according to features set (31) or (32), wherein the plasma polymer layer is obtainable according to the method according to at least one of the claims 1 to 16.

(34) Capacitor according to features set (31) or (32), wherein the plasma polymer layer is defined as in at least one of the claims 17 to 25.

(35) Method for producing an electrode according to at least one of the features sets (27) to (30), which comprises the following steps:
cleaning a surface of a metallic substrate,
depositing a plasma polymer layer onto the surface of the metallic substrate, and
applying an active material onto the surface of the plasma polymer layer facing away from the substrate,
characterised in that the plasma polymer layer is deposited at atmospheric pressure.

(36) Method according to features set (35), where the active material is applied in the form of a dispersion, in particular a slurry.

(37) Method according to features set (35) or (36), where the active material is lithium iron phosphate (LiFePO₄), lithium cobalt oxide (LiCoO₂), lithium manganese oxide spinel (LiMn₂O₄) or lithium nickel cobalt manganese oxide (Li (NiₓCo_{y}Mn_{z})O₂).

(38) Method according to at least one of the features sets (35) to (37), where the active material is treated further after applying through calendaring and drying.

(39) Method for producing a capacitor according to at least one of features sets (31) to (34), which comprises the following steps:
cleaning a surface of a metallic substrate,
depositing a plasma polymer layer onto the surface of the metallic substrate, and
applying an active material onto the surface of the plasma polymer layer facing away from the substrate,
characterised in that the plasma polymer layer is deposited at atmospheric pressure.

(40) Method according to features set (39), where the active material is applied in the form of a dispersion, in particular a slurry.

(41) Method according to features set (39) or (40), where the active material is lithium iron phosphate (LiFePO₄), lithium cobalt oxide (LiCoO₂), lithium manganese oxide spinel (LiMn₂O₄) or lithium nickel cobalt manganese oxide (Li (NiₓCo_{y}Mn_{z})O₂).

(42) Method according to at least one of the features sets (39) to (41), where the active material is treated further after applying through calendaring and drying.

(43) Battery cell comprising an electrode according to at least one of the features sets (27) to (30).

(44) Lithium ion accumulator, which comprises an electrode according to at least one of the features sets (27) to (30).

(45) Method according to at least one of the features sets (1) to (16), where the heterocyclic compound is a substituted or non-substituted 5-ring or 6-ring with a heteroatom selected from the group of oxygen, nitrogen and sulphur.

(46) Method according to features set (45), where the heterocyclic compound is tetrahydrofuran, tetrahydrothiophene, piperidine, pyrrolidine, 2,3-dihydrofuran, 2,5-dihydrofuran, 2,3-dihydrothiophene, 2,5-dihydrothiophene, 1-pyrroline, 2-pyrroline or 3-pyrroline.

(47) Method according to at least one of the features sets (1) to (16), (45) and (46), where the hydrocarbon with at least one functional group is a non-cyclic hydrocarbon with at least one functional group, selected from a C—C double bond, a C—C triple bond and a carbonyl group, or a cyclic hydrocarbon with at least one functional group, selected from a C—C double bond, C—C triple bond, carbonyl group, alcohol group and an amino group.

(48) Method according to features set (47), where the cyclic hydrocarbon with at least one functional group is a non-aromatic compound with at least two C—C double bonds and/or a cyclic ketone.

(49) Method according to features set (48), where the cyclic hydrocarbon with at least one functional group is cyclooctadiene, phellandrene, limonene, a terpinene or a quinone.

(50) Method according to features set (47), where the non-cyclic hydrocarbon is acetylene or squalene.

(51) Method according to at least one of the features sets (1) to (16) and (45) to (49), where the organic coating precursor compound is a heterocyclic compound, or a cyclic hydrocarbon with at least one functional group.

(52) Method according to at least one of the features sets (4) to (14) and (45) to (51), where a plasma nozzle is used, which comprises the following elements:
a housing, which forms a nozzle channel through which a process gas flows,
an electrode arranged in the nozzle channel,
a counter electrode,
a high-frequency generator for applying a voltage between the electrode and the counter electrode for forming a plasma jet, which exits from an outlet of the housing,
a multi-part coating nozzle head 60 arranged in the nozzle channel between the electrode and the outlet, consisting of an internal part 70 with an exit at the lower end of the internal part 70, an external part 80 and a feed area 90, which is formed by the space between the internal part 70 and the external part 80, wherein the exit at the lower end of the internal part 70 comprises an internal structure 200, which constitutes a means for hindering the entry of the light arc or the light arc-like discharge into the feed area 90 in the nozzle head, and
a means for feeding the evaporated, at least one organic coating precursor compound into the plasma jet in the relaxing area of the plasma in the feed area (90) in the nozzle head.

(53) Method according to features set (52), where the internal structure 200 is an internal grid structure, an internal hole structure, a narrowing of the exit at the lower end of the internal part 70, preferably an edge, or an isolator.

(54) Article according to at least one of the features sets (16) to (26), where the plasma polymer layer preferably has a layer resistance within a range of 2 to 50,000 Ohm, more preferably a layer resistance of less than 35,000 Ohm, and most preferably a layer resistance of less than 20,000 Ohm at a layer thickness within a range of 10 to 100 nm, wherein the layer resistance equals the impedance measured by means of electrochemical impedance spectroscopy at 0.01 Hz.

### EXAMPLES

The invention is illustrated with reference to embodiment examples hereafter.

An article according to the third and fourth aspect is produced and investigated in the example, using the method according to the first aspect of the invention.

An organic plasma polymer layer with a layer thickness of less than 1 μm was deposited in the relaxing plasma (afterglow plasma) at atmospheric pressure onto an aluminium alloy as the substrate. For this, an atmospheric pressure plasma system with a plasma nozzle from company Plasmatreat was used. The organic precursor compound (20 g/h cyclopentanol) was fed into the afterglow area of the plasma in an evaporated condition together with 2 nL/min nitrogen as carrier gas at a distance of 10 mm from the nozzle outlet. The displacement speed of the nozzle, i.e. the speed with which the nozzle was moved relative to the substrate, was 10 m/min here. A jacket jet of inert gas can additionally be generated at the nozzle outlet through the nozzle itself for this. Excitation of the plasma took place through an arc-like discharge in a jet system, using nitrogen as a process gas (ionisation gas, 29 nL/min). The article consisting of a substrate and the plasma polymer layer deposited onto the same was stored at room atmosphere and the plasma polymer layer subsequently characterised.

The unit “nL” stands for standard litres as part of the present invention. A standard litre equals the gas quantity that would take up the volume of 1 litre under normal conditions.

The chemical composition of the coating was determined by means of X-ray Photoelectron Spectroscopy (XPS) (see Table 1). The XPS signals of the functional groups recorded are analysed with a fit function and quantified in this way (Table 2).

TABLE 1

| Coating precursor compound | Cyclopentanol |
|---|---|
| Molar ratio C:O | 2.5:1 |
| C [at %] | 63 |
| O [at %] | 25 |
| N [at %] | 12 |
| other [at %] | <1 |

TABLE 2

| Coating precursor compound | Cyclopentanol |
|---|---|
| Aliphatic groups [at %] | 27 |
| Alcohol/ether groups [at %] | 18 |
| Carbonyl groups [at %] | 11 |
| Carbonate/ester groups [at %] | 5 |

Table 1 shows that the plasma polymer layer deposited according to the method according to the invention has a high carbon content of 63% with regard to the total atomic mass without hydrogen. The high carbon-to-oxygen ratio of 2.5 to 1 also shows that it was possible to mostly suppress the oxidation of the organic coating precursor compound.

Table 2 shows that the surface of the plasma polymer layer deposited according to the method according to the invention has a high content of functional groups. As the organic coating precursor compound contains an alcohol group the high content of alcohol and ether groups indicates that a certain content of functional groups remains intact after depositing the plasma polymer layer. Ether groups are probably generated through the condensation of two alcohols and thus also indicate stability of the functional group in the method according to the invention. Surface functionalities contribute towards the adhesion strength of the plasma polymer layer.

In a further embodiment example an organic plasma polymer layer was deposited according to the method described above with layer thicknesses of 30 nm and 90 nm, respectively, in the relaxing plasma (afterglow plasma) at atmospheric pressure onto a wafer with a 600 nm thick copper layer as the substrate. Acetylene was used as the organic precursor compound. The layer thickness was determined by means of ellipsometry on a silicon wafer deposited at the same time.

The layer resistances of the layers produced in this way were determined in the standard way with electrochemical impedance measurements as described in the online encyclopaedia Römpp Online, amongst others

(https://roempp.thieme.de/roempp4.0/do/data/RD-09-00371, downloaded on 30 Jan. 2018). The measurement includes the following steps, which are each known to the person skilled in the art. A conductive test solution was first produced as a contact medium for the plasma polymer layer to be investigated. A measurement of water absorption, i.e. the capacity change, then took place by means of electrochemical impedance spectroscopy in the plasma polymer layers to be measured on the conductive substrate. The evaluation of the electrochemical impedance spectroscopy then followed for the purpose of determining layer resistances. The dielectric constant E of the layers was also determined by means of electrochemical impedance spectroscopy within a frequency range of 1 Hz to 10 kHz. The results are illustrated in Table 3. The high values of the dielectric constants of the plasma polymer layers investigated indicate a good connection of the substrates with the plasma polymer layers, as the curve shape of the measurement signals indicates the presence of pores in the plasma polymer layers.

TABLE 3
(values calculated from three independent measurements)

| Layer thickness of the | | |
|---|---|---|
| plasma polymer layer | Impedance at 0.01 Hz | Dielectric constant ε |
| 30 nm ± 4 | 15,250 Ohm ± 5,200 | 325 ± 45 |
| 90 nm ± 7 | 31,800 Ohm ± 2,600 | 1,510 ± 185 |

1. Method for depositing a plasma polymer layer in an atmospheric pressure plasma onto a metallic substrate, wherein the plasma is generated by a discharge between electrodes,
comprising feeding at least one organic coating precursor compound into an area of relaxing plasma, and depositing the resulting compound onto the metallic substrate as a plasma polymer layer,
wherein nitrogen or a forming gas is used as a process gas, and
wherein the at least one organic coating precursor compound is selected from the group consisting of heterocyclic compounds, cyclic non-functionalised hydrocarbons and hydrocarbons with at least one functional group selected from the group consisting of an alcohol group, a carbonyl group, a carboxyl group, an amino group, a multiple carbon-carbon bond group, a multiple carbon-nitrogen bond group and a multiple nitrogen-nitrogen bond group.

2. Method according to claim 1, wherein the at least one organic coating precursor compound is fed into the area of the relaxing plasma as a gas mixture together with an inert gas comprising nitrogen, wherein the area of the relaxing plasma lies outside of the discharge, which discharge comprises a light arc or a light arc-like discharge.

3. Method according to claim 1, where the plasma comprises a plasma jet.

4. Method according to claim 3, further comprising generating a jacket jet of inert gas around a nozzle outlet of a plasma nozzle of the plasma jet.

5. Method according to claim 1, where the at least one organic coating precursor compound is selected from the group consisting of a cycloalkane, a terpene and a cyclic hydrocarbon which has at least one amine and/or alcohol group.

6. Method according to claim 5, where the organic coating precursor compound is selected from the group consisting of limonene, cyclopentanol, cyclooctane and 1,5-cyclooctadiene.

7. Method according to claim 1, where a plasma nozzle is used which comprises the following elements:
a housing, which forms a nozzle channel through which a process gas flows,
an electrode arranged in the nozzle channel,
a counter electrode,
a high-frequency generator for applying a voltage between the electrode and the counter electrode for forming a plasma jet, which exits from an outlet of the housing,
a coating nozzle head with an internal grid structure arranged in the nozzle channel between the electrode and the outlet, and
a structure for feeding the evaporated at least one organic coating precursor compound into the plasma jet in the relaxing area of the plasma in the nozzle head.

8. Article comprising a metallic substrate with a surface and a plasma polymer layer on the surface, characterised in that the plasma polymer layer contains conjugated multiple bonds.

9. Article comprising a metallic substrate with a surface and an organic plasma polymer layer on the surface, characterised in that the plasma polymer layer is deposited at atmospheric pressure.

10. Article according to claim 8, in which the plasma polymer layer contains less than 10% silicon, with regard to its total atomic number.

11. Article according to claim 8, in which at least 10% of the surface atoms include an oxygenic functional group on the surface of the plasma polymer layer facing away from the substrate.

12. Article according to claim 8, in which the molar ratio C:O in the plasma polymer layer is greater than 2, and in which the composition of the plasma polymer layer with regard to its total atomic number without hydrogen contains minimally 50 and maximally 90 atomic percent C, minimally 0 and maximally 30 atomic percent O, and minimally 0 and maximally 20 atomic percent N.

13. Article according to claim 8, wherein the plasma polymer layer is produced by the method according to claim 1.

14. Article comprising a metallic substrate with a surface and a plasma polymer layer deposited on the surface, wherein the plasma polymer layer is obtainable by the method according to claim 1.

15. Electrode comprising
a metallic substrate with a surface,
a plasma polymer layer on the surface of the metallic substrate, and
a layer comprising an active material on the surface of the plasma polymer layer facing away from the substrate.

16. Electrode according to claim 15, in which the active material is selected from the group consisting of lithium iron phosphate, lithium cobalt oxide, lithium manganese oxide spinel and lithium nickel cobalt manganese oxide.

17. Electrode according to claim 15, wherein the plasma polymer layer is obtainable according to the method of claim 1.

18. Electrode according to claim 15, wherein the plasma polymer layer is defined by the article of claim 8.

19. Capacitor, which
comprises a metallic substrate with a surface,
a plasma polymer layer on the surface of the metallic substrate, and
a layer comprising an active material on the surface of the plasma polymer layer facing away from the substrate,
wherein the plasma polymer layer is defined by claim 8.

20. Method for producing an electrode according to claim 15, which comprises the following steps:
cleaning a surface of a metallic substrate,
depositing a plasma polymer layer onto the surface of the metallic substrate, and
applying an active material onto the surface of the plasma polymer layer facing away from the substrate,
characterised in that the plasma polymer layer is deposited at atmospheric pressure.

21. Method according to claim 20 where the active material is applied in the form of a dispersion.

22. Method according to claim 20, where the active material is selected from the group consisting of lithium iron phosphate, lithium cobalt oxide, lithium manganese oxide spinel and lithium nickel cobalt manganese oxide.

23. Method for producing a capacitor according to claim 19, which comprises the following steps:
cleaning a surface of a metallic substrate,
depositing a plasma polymer layer onto the surface of the metallic substrate, and
applying an active material onto the surface of the plasma polymer layer facing away from the substrate,
characterised in that the plasma polymer layer is deposited at atmospheric pressure.

24. Battery cell comprising an electrode according to claim 15.

25. Lithium ion accumulator, which comprises an electrode according to claim 15.

26. Method according to claim 4, where the plasma nozzle comprises the following elements:
a housing, which forms a nozzle channel through which a process gas flows,
an electrode arranged in the nozzle channel,
a counter electrode,
a high-frequency generator for applying a voltage between the electrode and the counter electrode for forming a plasma jet, which exits from an outlet of the housing,
a multi-part coating nozzle head arranged in the nozzle channel between the electrode and the outlet, comprising an internal part with an exit at the lower end of the internal part, an external part and a feed area, which is formed by the space between the internal part and the external part, wherein the exit at the lower end of the internal part comprises an internal structure, which comprises a structure for hindering entry of a light arc or a light arc-like discharge into the feed area, and
a structure for feeding the evaporated at least one organic coating precursor compound into the plasma jet in the relaxing area of the plasma in the feed area in the nozzle head.
